(19) United States
(12) Patent Application Publication
(10) Pub. No.: US 2013/0198620 A1
(43) Pub. Date: Aug. 1, 2013

(54) METHOD AND SYSTEM FOR PERFORMING SYNCHRONOUS DOCUMENT CONVERSION

(71) Applicants: Zehua Zhou, Issaquah, WA (US); Zeyad Rajabi, Bellevue, WA (US); James Leung, Redmond, WA (US); Miguel Gonzalez-Gongora, Redmond, WA (US)

(72) Inventors: Zehua Zhou, Issaquah, WA (US); Zeyad Rajabi, Bellevue, WA (US); James Leung, Redmond, WA (US); Miguel Gonzalez-Gongora, Redmond, WA (US)

(73) Assignee: Microsoft Corporation, Redmond, WA (US)

(21) Appl. No.: 13/557,050

(22) Filed: Jul. 24, 2012

Related U.S. Application Data
(60) Provisional application No. 61/591,222, filed on Jan. 26, 2012.

(51) Int. Cl. G06F 17/00

(52) U.S. Cl. 715/255

(57) ABSTRACT

Embodiments of the present disclosure provide a method and system for converting a document from a first format to a second format. Embodiments disclosed herein include receiving a request to convert the document from the first format to the second format. The location of the document is then identified and the document is uploaded and converted from the first format to the second format. When the conversion is complete, the document is saved in a second location that was identified in the request. As part of this process, periodic updates to the conversion process are transmitted to a requesting device.

### PRIORITY

The present application claims priority to U.S. Provisional Patent Application No. 61/591,222 filed on Jan. 26, 2012. The aforementioned application is hereby incorporated by reference in its entirety.

### BACKGROUND

Computing services, such as document conversion services, often operate against a large set of documents or files. The processing of these documents or files is typically performed asynchronously. As a result, when a user requests conversion of a particular document or file, the document or file to be converted is placed in a queue. The user may then be required to wait, at times for a variable amount of time, for the request to be processed. In some cases, the document to be converted is placed in a queue along with other documents and the document is not converted until a batch conversion process is started on a number of documents. Additionally, typical batch conversion processes do not notify users of the status of the conversion process or when the conversion process has been completed.

It is with respect to these and other general considerations that embodiments of the present disclosure have been made. Also, although relatively specific problems have been discussed, it should be understood that the embodiments should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Embodiments of the present disclosure provide a method and system for converting a document from a first format to a second format when the document is stored on an external storage service, such as, for example, a cloud storage service. Embodiments disclosed herein include submitting a request to convert the document from the first format to the second format. The location of the document is then identified and the document is uploaded and converted from the first format to the second format. When the conversion is complete, the document is saved in a second location that was identified in the request. As part of this process, periodic updates to the conversion process are transmitted to a requesting device.

One or more embodiments also provide for a system and method for converting a document from a first format to a second format when the document is stored on a local storage device. According to such embodiments, the document to be converted is stored in a storage location on a local computing device. The size of the document to be converted is then determined. In certain embodiments, if the size of the document exceeds a size threshold, the document is divided into multiple segments with each segment including an indicator as to whether the segment is the final segment of the document, and each segment is transmitted to a remote computing device. However, if the document does not exceed the size threshold, the entire document is transmitted to the remote computing device. Once the document has been converted, the entire document is transmitted from the remote computing device to the local computing device if the converted document is less than the size threshold. However, if the size of the converted document exceeds the size threshold, segments of the converted document are requested by the local computing device until a segment is received that includes an indicator that the particular segment is the final segment of the converted document.

Embodiments may be implemented as a computer process, a computing system or as an article of manufacture such as a computer program product or computer readable media. The computer program product may be computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following Figures in which:

FIG. 1 illustrates a system for converting documents from a first format to a second format in a synchronous manner according to one or more embodiments;

FIG. 2 illustrates a method for converting a document that is saved on a remote storage service from a first format to a second format according to one or more embodiments;

FIG. 3 illustrates a method for converting a document that is saved on a local storage device from a first format to a second format according to one or more embodiments;

FIG. 4 illustrates a tablet computing device executing one or more embodiments disclosed herein;

FIG. 5 illustrates a block diagram of a computing environment suitable for implementing one or more embodiments disclosed herein;

FIG. 6A illustrates one embodiment of a mobile computing device executing one or more embodiments disclosed herein;

FIG. 6B is a simplified block diagram of an exemplary mobile computing device suitable for practicing one or more embodiments disclosed herein; and

FIG. 7 is a simplified block diagram of an exemplary distributed computing system suitable for practicing one or more embodiments disclosed herein.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

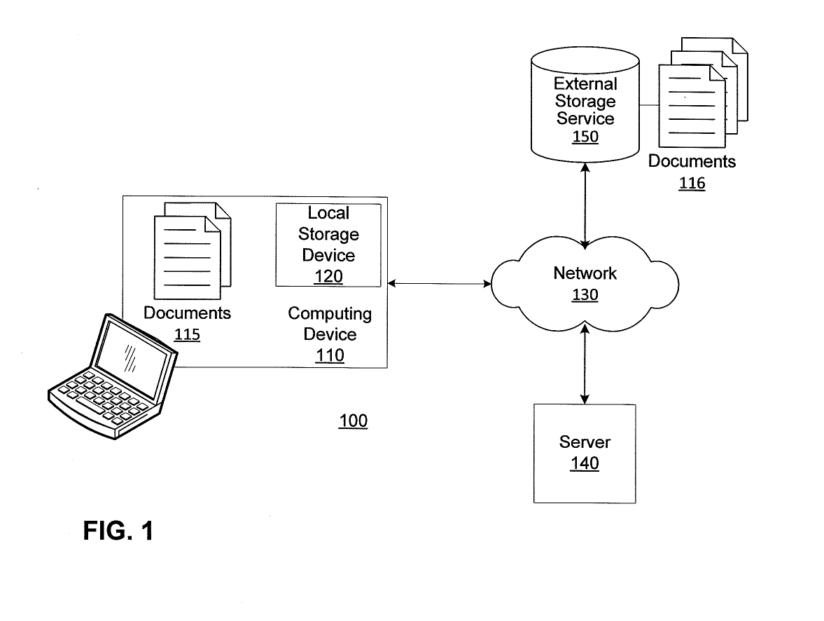

FIG. 1 illustrates a system 100 for converting a document from a first format to a second format according to one or more embodiments. As shown in FIG. 1, the system 100 includes a local computing device 110 that includes a local storage device 120 configured to store one or more documents 115. The local computing device 110 may be a desktop or laptop computer, tablet computer, smartphone, personal digital assistant and the like. In certain embodiments, the one or more documents 115 may be word processing documents, spreadsheet documents, slide presentation documents, and the like.

As shown in FIG. 1, the system 100 may also enable the local computing device to access an external storage service 150 and store one or more documents 116 on the external storage service. In certain embodiments, documents 115 and documents 116 may be the same documents or different documents. In order to access the external storage service 150, the computing device 110 may be required to access a network 130 to gain access to the external storage service 150. In certain embodiments, a user may be required to provide credentials to the external storage service 150 in order to gain access to, store, and retrieve documents located on the external storage service 150. User credentials may include a username and password or other input that is associated with and identifies a particular user. For example, the user credentials may include a WINDOWS LIVE ID, an email username and password, and the like. In another embodiment, a particular user may use single sign-on credentials which enable the user to access the external storage service 150 as well as other remote or local services.

In certain embodiments, the external storage service 150 may be a cloud computing storage service, a file hosting service, or other such service offered by a third party. Examples of such services include SKYDRIVE, SHAREPOINT and MySite by Microsoft Corporation of Redmond, Wash., DROPBOX by Officeware Corporation, and the like. Although specific examples have been given, it is contemplated that other external storage services may be used with embodiments disclosed herein.

Use of an external storage service 150 not only enables a user to save a document in a particular location in response to save request, but as will be explained in detail below, a user may select a particular identifier (e.g., a URL that specifies the location of a document) associated with a document stored on the external storage service 150 and submit a request that the document be converted from a first format to a second format. When the request is received, the document is located, converted, and saved back into the external storage service 150.

Referring back to FIG. 1, the system 100 also includes a server 140 that is configured to: (i) store and manage a list of conversion jobs (both synchronous conversion jobs and asynchronous conversion jobs), and (ii) initiate the document conversion. In certain embodiments, the server 140 may be configured to process the conversion job or outsource the conversion job to one or more worker services (not shown) that will perform the conversion job. Additionally, the server 140 may be configured to track the status of each conversion job as well as the worker service, or instance of a worker service (e.g., a copy of a worker service), that has been assigned a particular conversion job. The server 140 may also be configured to periodically send updates regarding the status of the conversion to the local computing device 110. The server 140 may also be configured to send status updates to the local computing device 110 in response to one or more requests submitted by the local computing device 110.

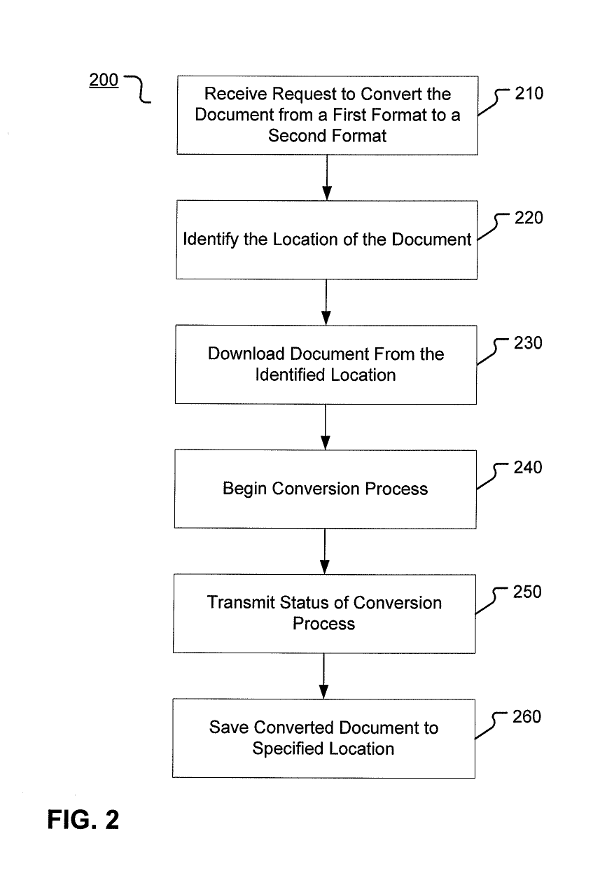

FIG. 2 illustrates a method 200 for converting a document that is saved on an external storage service from a first format to a second format according to one or more embodiments. For example, a document may be saved on the external storage service in a free flow format (e.g., word processing format) and a user may want to convert the document from the free flow format to a fixed flow format (e.g., a .PDF document and the like). As such, a computer system, such as, for example, computer system 100 may employ the method 200 to synchronously perform the document conversion.

Method 200 begins at operation 210 in which a remote computing device receives a request to synchronously convert a document that is saved on an external storage service (e.g., cloud computing service) from a first format to a second format. In certain embodiments, the remote computing device that receives the synchronous conversion request may be a server, such as server 140 (FIG. 1). In such embodiments, the remote computing device may receive the synchronous conversion request from a client computing device or a local computing device, such as local computing device 110 (FIG. 1). In an embodiment, when the request is received by the remote computing device, the remote computing device generates a job identifier that is associated with the synchronous conversion request. Thereafter, the job identifier may be used by either the remote computing device or the local computing device to obtain status updates corresponding to the synchronous conversion request associated with the job identifier.

Once the request is received by the remote computing device, the remote computing device identifies 220 the document to be converted based on a location of the document. In an embodiment, the location of the document is identified by a Uniform Resource Locator (URL) contained within the request. The request may also include a destination URL that identifies the location to which the converted document is to be stored once the conversion process has been completed by the remote computing device.

When the document has been identified, flow proceeds to operation 230 in which the remote computing device downloads the identified document. When the download is complete, the remote computing device begins 240 the conversion process. In certain embodiments, the remote computing device may send a status message to the local computing device once the entire document has been downloaded and when the conversion process has started. In another embodiment, the local computing device may periodically poll the remote computing device to obtain a status update of one or more conversion jobs submitted by the local computing device. In such embodiments, the local computing device may include one or more job identifiers in the request and obtain status updates for the corresponding conversion processes.

In certain embodiments, the remote computing device may be configured to perform each document conversion. In other embodiments, the remote computing device may assign various document conversion processes to one or more worker services or instantiations of one or more worker services. Additionally, the remote computing device may be configured to track a queue of synchronous conversion requests (e.g., requests by a user to process documents immediately, or as soon as higher priority synchronous conversion requests (e.g., the synchronous conversion requests already in the queue) are complete), as well as a queue of asynchronous conversion requests (e.g., conversions requests that are queued and in which batches of conversions in the queue are started at periodic intervals).

Maintenance of each queue is necessary to enable the remote computing device to not only track the status of each asynchronous and synchronous conversion job, but also to ensure that synchronous conversion requests are performed before asynchronous requests as each synchronous conversion request has a higher priority than every asynchronous conversion request. Thus, if a computing device has a queue of five asynchronous conversion requests, and a synchronous conversion request is received, the newly received synchronous conversion request takes priority over all five asynchronous requests. If there are multiple synchronous conversion requests in the synchronous conversion queue, the new synchronous conversion is placed at the end of queue and each synchronous conversion request is processed in a first in, first-out (FIFO) manner.

During the conversion process, the remote computing device may transmit 250 one or more status updates to the local computing device. In certain embodiments, the remote computing device may periodically transmit the status updates after a predetermined time period has elapsed. In another embodiment, transmission of the status update may be in response to a status request submitted by the local computing device. Status updates and status requests may include a job identifier that is associated with a particular synchronous conversion request. Although a single job identifier is mentioned, it is contemplated that the local computing device may submit a single request with multiple job identifiers. In response to the request with the multiple job identifiers, the remote computing device may provide updates for each of the conversion request associated with the respective job identifiers.

In certain embodiments, the response from the remote computing device includes one or more error codes that identify the status of the conversion job associated with a particular job identifier. Exemplary error codes include: (i) a null—that indicates the immediate conversion job is complete and has succeeded, (ii) a −1—that indicates an unknown failure, (iii) 0—that indicates that the immediate conversion job is still being processed, (iv) a 1—that indicates that the input file was not found, (v) a 2—that indicates that insufficient permissions have been set to enable the input file to be downloaded, (vi) a 3—that indicates that a Usertoken used for conversion expired before the input file could be downloaded, (vii) a 4—that insufficient permissions have been set to enable the converted file to be uploaded, (viii) a 5—that indicates that the Usertoken used for conversion expired before the converted file could be uploaded, (ix) a 6—that indicates that the input file could not be downloaded for some unknown reason, (x) a 7—that indicates that the converted filed could not be uploaded for some unknown reason, (xi) a 9—that indicates the worker assigned to convert the document has died, (xii) a 10—that indicates that the conversion request exceeded the maximum conversion time, (xiii) an 11—that indicates that the number of in-progress immediate conversion requests exceeds the limit specified by an administrator, and (xiv) a 12—that indicates that the administrator has specified that the remote computing device cannot accept synchronous conversion requests. Although specific errors and error codes have been given, it is contemplated that additional errors and error codes may be provided to the local computing device in response to a status update request.

Once the conversion process is complete, the remote computing device uploads 260 the converted document to the external storage service and notifies the client computing device of the completed status. In one or more embodiments, the remote computing device stores the results of each status request in a data structure. This data structure is provided to the client computing device in the given output URL (e.g., the output URL identified in the initial conversion request). If the first element of data structure is null, this indicates that the conversion process is complete and the client computing device can access the converted document.

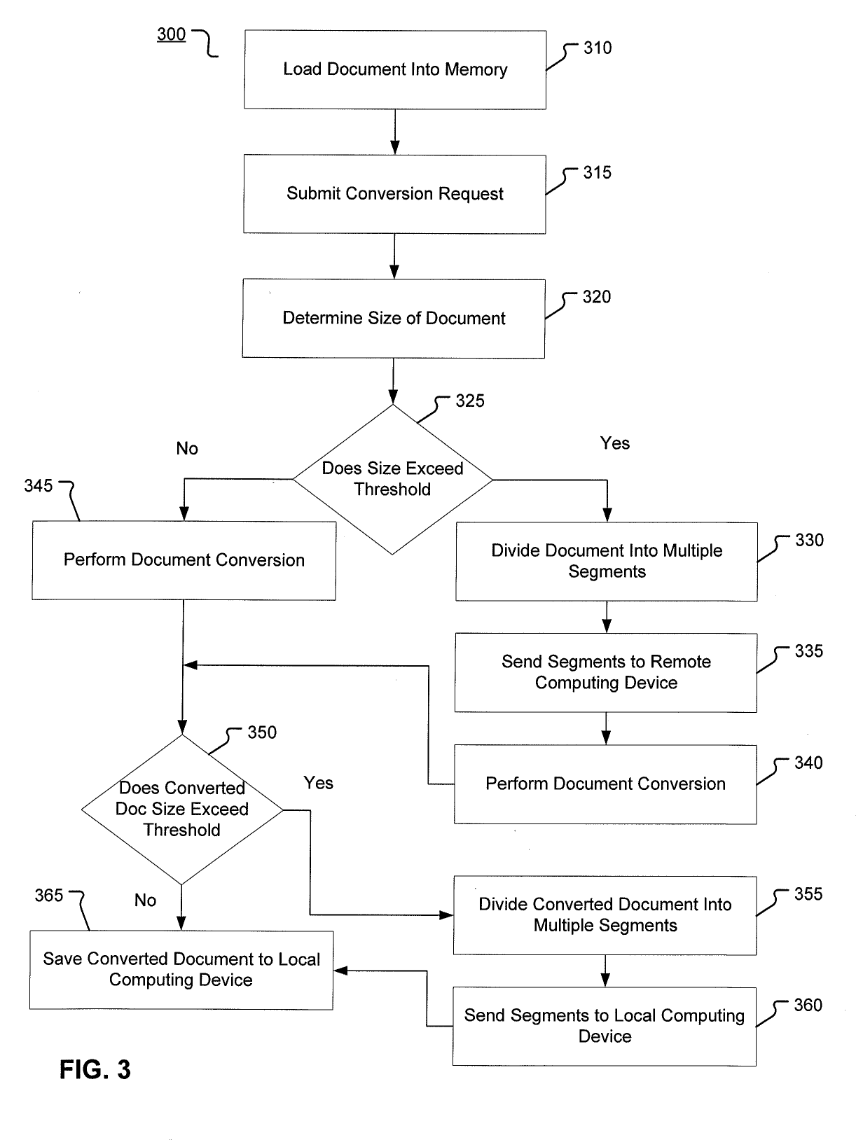

FIG. 3 illustrates a method 300 for converting a document that is saved on a local storage device from a first format to a second format according to one or more embodiments. For example, a free flow format document may be stored on a storage device of a local computing device, such as local computing device 110 (FIG. 1) and a user may want to convert the free flow format document to a fixed flow format document. As such, a computer system, such as, for example, computer system 100 may employ the method 300 to perform a synchronous document conversion.

Method 300 begins at operation 310 in which a document stored on a storage device of the local computing device is loaded into a memory device. Once the document has been stored in the memory device, flow proceeds to operation 315 in which a document conversion request is submitted by the local computing device to a remote computing device. In certain embodiments, when the request is submitted, a job identifier is created and associated with the particular synchronous conversion request.

Once the request is submitted, the size of the document to be converted is determined 320. In certain embodiments, if a document exceeds the size threshold, the document is divided into multiple segments, with each segment being less than or equal to the size threshold. In an exemplary embodiment, the size threshold is set to 2 MB although different size thresholds are contemplated.

If it is determined 325 that the size of the document to be converted exceeds a document size threshold, flow proceeds to operation 330 in which the document is divided into multiple segments. As discussed above, in embodiments where the size threshold is 2 MB, each segment must be equal to or less than the 2 MB limit. Once the document is divided into segments, each segment is sent 335 to the remote computing device. In certain embodiments, each segment includes an indicator that identifies whether a particular segment is the final document segment. Such an identifier may be necessary to notify the remote computing device when to start the conversion process because the remote computing device has no knowledge of the total size of the document or the number of segments of the document to be converted. Additionally, in certain embodiments, the document conversion process does not begin until the entire document has been received.

When all of the segments have been received, flow proceeds to operation 340 and the document conversion process begins. As discussed above, during the document conversion process and/or the segmentation process, the remote computing device may periodically transmit one or more status updates to the local computing device. In another embodiment, the local computing device may periodically poll the remote computing device for status updates of one or more conversion jobs.

Referring back to operation 325, if it is determined in operation 325 that the size of the document to be converted does not exceed the size threshold, flow passes to operation 345 in which the document is converted from the first format to the second format.

Once the document has been converted, the remote computing device may notify the local computing device that the conversion process is complete. Such a notification may be automatically sent by the remote computing device to the local computing device in response to the process completing or in response to a status request submitted by the local computing device.

The local computing device may then request the converted document from the remote computing device. In response to this request, a determination 350 is made as to whether the converted document exceeds the size threshold. If the size of the converted document exceeds the size threshold, flow proceeds to operation 355 and the converted document is divided into multiple segments and each segment is sent 360 from the remote computing device to the local computing device. In certain embodiments, each segment includes an indicator that identifies whether that particular segment is the final segment of the converted document. Once the final segment is received, the local computing device reconstructs the segments to form the converted document and the reconstructed converted document is saved 365 on a local storage device.

Referring back to operation 350, if it is determined that the converted document does not exceed the size threshold, flow proceeds to operation 365 and the converted document is sent to the local computing device and saved. In certain embodiments, if there are multiple documents that have been converted but not yet transmitted back to the local computing device, and the combined size of two or more documents does not exceed the size threshold, the two or more documents may be appended in a single communication and transmitted in response to a single request made by the local computing device. Although two documents are specifically mentioned, it is contemplated that any number of documents may be appended in a single communication up until the total size of the combined documents meets the maximum size threshold.

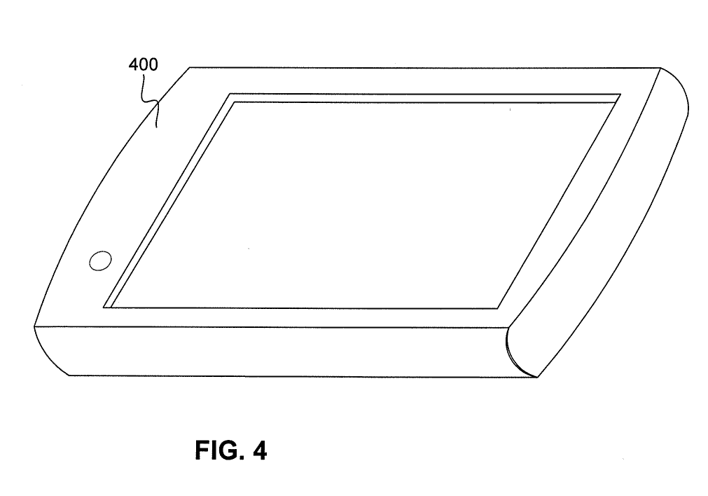

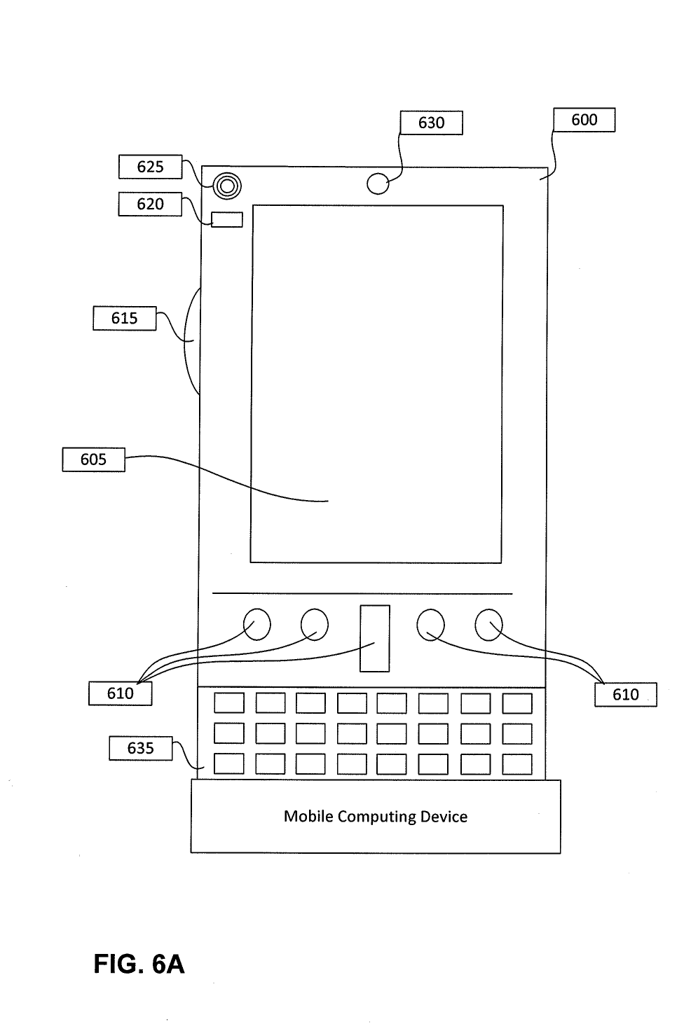

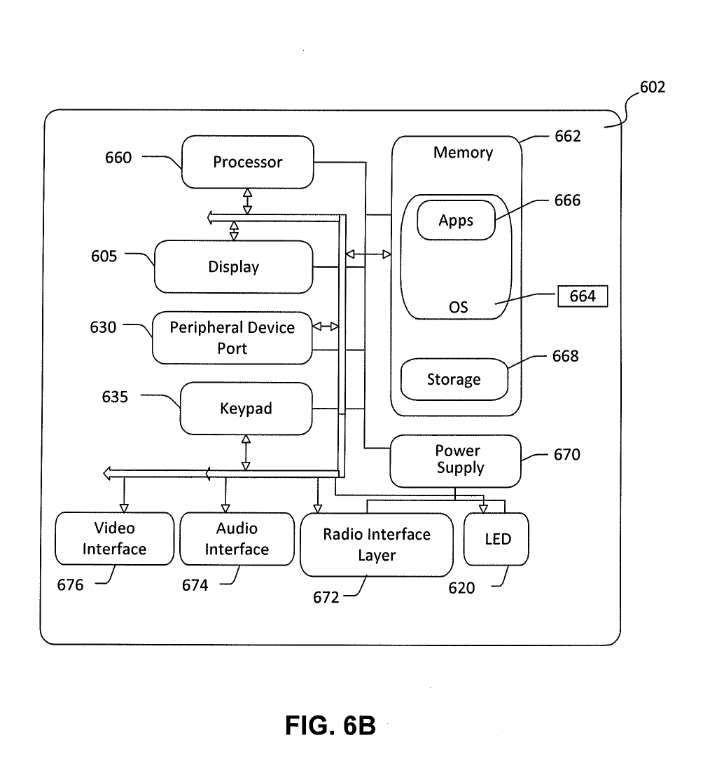

The embodiments and functionalities described herein may operate via a multitude of computing systems including, without limitation, wired and wireless computing systems, mobile computing systems (e.g., mobile telephones, netbooks, tablet or slate type computers, and laptop computers). FIG. 4 illustrates an exemplary tablet computing device 400 executing an embodiment of the present disclosure. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 6 through 8 and the associated descriptions provide a discussion of a variety of operating environments in which embodiments of the present disclosure may be practiced. However, the devices and systems illustrated and discussed with respect to FIGS. 6 through 8 are for purposes of example and illustration and are not limiting of a vast number of computing device configurations that may be utilized for practicing embodiments of the present disclosure, described herein.

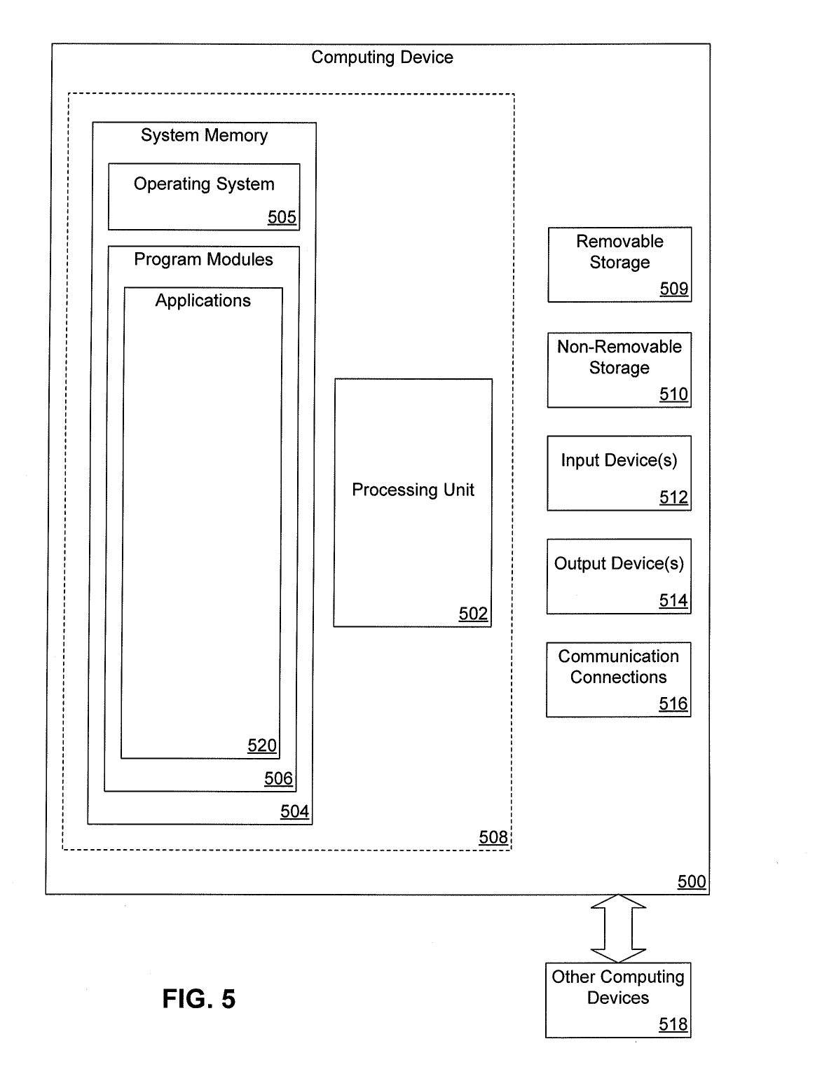

FIG. 5 is a block diagram illustrating exemplary physical components of a computing device 500 with which embodiments of the present disclosure may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination. The system memory 504 may include an operating system 505, one or more program modules 506, which are suitable for running applications 520. The operating system 505, for example, may be suitable for controlling the operation of the computing device 500. Furthermore, embodiments of the present disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, for example, one or more of the stages of the methods described herein. The aforementioned process is an example, and the processing unit 502 may perform other processes. Other program modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the present disclosure, program modules may include routines, programs, components, data structures, and other types of structures that may perform particular tasks or that may implement particular abstract data types. Moreover, embodiments of the present disclosure may be practiced with other computer system configurations, including hand-held devices, multiprocessor systems, microprocessor-based or programmable consumer electronics, minicomputers, mainframe computers, and the like. Embodiments of the present disclosure may also be practiced in distributed computing environments where tasks are performed by remote processing devices that are linked through a communications network. In a distributed computing environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the present disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device 500 on the single integrated circuit (chip). Embodiments of the present disclosure may also be practiced using other technologies capable of performing logical operations such as, for example, AND, OR, and NOT, including but not limited to mechanical, optical, fluidic, and quantum technologies. In addition, embodiments of the present disclosure may be practiced within a general purpose computer or in any other circuits or systems.

Embodiments of the present disclosure, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 504, the removable storage device 509, and the non-removable storage device 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500. The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, or serial ports, and other connections appropriate for use with the applicable computer readable media.

FIGS. 6A and 6B illustrate a mobile computing device 600, for example, a mobile telephone, a smart phone, a tablet personal computer, a laptop computer, and the like, with which embodiments of the present disclosure may be practiced. With reference to FIG. 6A, an exemplary mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 600, in alternative embodiments, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Embodiments of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present disclosure.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world”, via a communications carrier or service provider. Transmissions to and from the radio 672 are conducted under control of the operating system 664. In other words, communications received by the radio 672 may be disseminated to the application programs 666 via the operating system 664, and vice versa.

The radio 672 allows the system 602 to communicate with other computing devices, such as over a network. The radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 602 provides notifications using the visual indicator 620 that can be used to provide visual notifications and/or an audio interface 674 producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

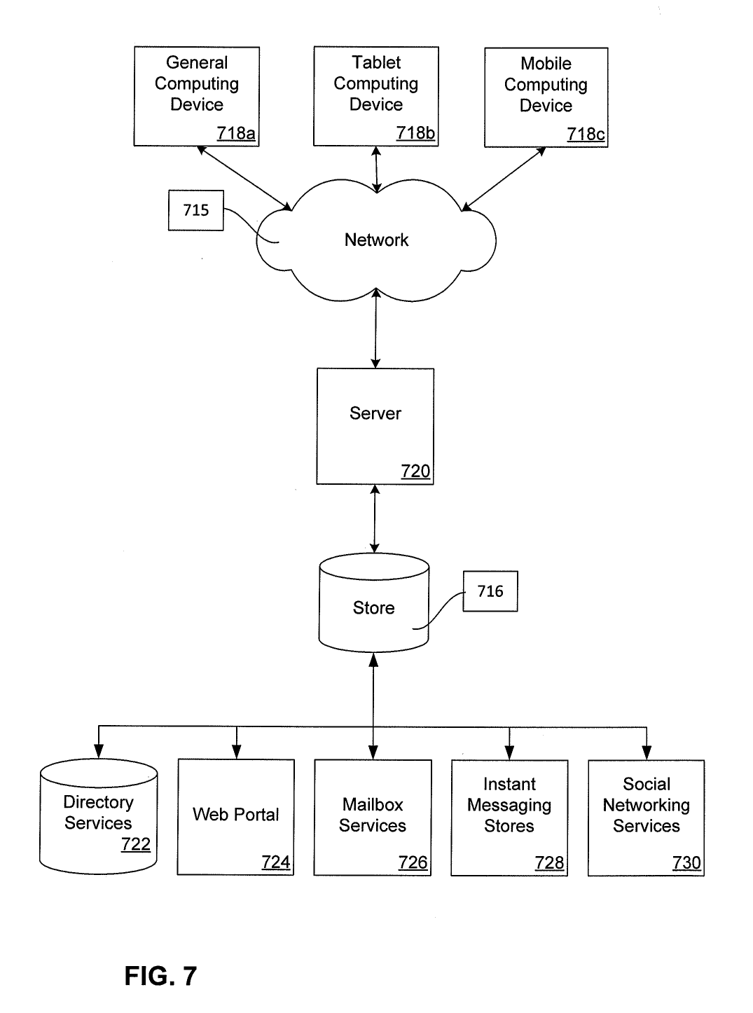

FIG. 7 illustrates one embodiment of the architecture of a system for providing converted documents to one or more client devices, as described above. In certain embodiments, the converted documents may be stored in different communication channels or other storage types. For example, various documents, including the converted documents, may be stored using a directory service 722, a web portal 724, a mailbox service 726, an instant messaging store 728, or a social networking site 730. The various components of the system 100 use any of these types of systems or the like for enabling data utilization, as described herein. A server 720 may provide the converted paragraphs to clients. The server 720 may provide the converted paragraphs and the status updates over the web to clients through a network 715. By way of example, the client computing device 718 may be implemented as the computing device 700 and embodied in a personal computer 718a, a tablet computing device 718b and/or a mobile computing device 718c (e.g., a smart phone). Any of these embodiments of the client computing device 718 may obtain content from the store 716. In various embodiments, the types of networks used for communication between the computing devices that make up the present disclosure include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

One skilled in the relevant art may recognize, however, that the embodiments may be practiced without one or more of the specific details, or with other methods, resources, materials, etc. In other instances, well known structures, resources, or operations have not been shown or described in detail merely to avoid obscuring aspects of the embodiments.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for converting a document from a first format to a second format, the method comprising:
receiving a request to convert the document from the first format to the second format;
identifying a location of the document, the location of the document being included in the request;
converting the document from the first format to the second format, wherein converting the document from the first format to the second format comprises:
determining if the size of the document exceeds a size threshold; and
dividing the document into multiple segments when the size of the document exceeds the size threshold, wherein each segment includes an indicator as to whether a particular segment is a final segment of the document; and
periodically sending an update notification based on a status associated with the document conversion.

2. The method of claim 1, wherein identifying a location of the document includes identifying the document using a Uniform Resource Locator (URL) associated with the document.

3. The method of claim 1, wherein the document is stored on an external storage service.

4. The method of claim 3, wherein the external storage service is a cloud storage service.

5. The method of claim 1, further comprising storing the converted document in a second location, wherein the second location is identified in the request.

6. The method of claim 1, wherein periodically sending an update notification includes sending the update notification based on a received status request.

7. The method of claim 1, further comprising maintaining at least one queue of conversion requests.

8. The method of claim 1, further comprising determining whether the conversion request is a synchronous request or an asynchronous request.

9. The method of claim 8, placing a higher priority on a synchronous request, wherein placing a higher priority on a synchronous request includes moving the synchronous request ahead of any pending asynchronous requests.

10. A method for converting a document from a first format to a second format, the method comprising:
storing the document in a storage location;
determining a size of the document;
if the size of the document exceeds a size threshold:
dividing the document into multiple segments, wherein each segment includes an indicator as to whether a particular segment is a final segment of the document; and
transmitting each of the multiple segments to a remote computing device;
if the size of the document does not exceed a size threshold:
transmitting the document to the remote computing device; and
in response to receiving notification from the remote computing device that the document has been converted:
receiving the entire converted document from the remote computing device if the converted document is less that the size threshold; and
receiving one or more segments of the converted document from the remote computing device, wherein each of the one or more segments include an indicator as to whether a particular segment is a final segment of the converted document.

11. The method of claim 10, wherein receiving the entire converted document includes receiving at least a second converted document, if a size of the converted document and a size of the at least the second converted document do not exceed the size threshold.

12. The method of claim 10, further comprising saving the converted document to the storage location.

13. The method of claim 10, wherein the storage location is a local storage location.

14. A computer-readable storage medium encoding computer executable instructions which, when executed by at least one processor, performs a method for converting a document from a first format to a second format, the method comprising:
storing the document in a storage location;
determining a size of the document;
if the size of the document exceeds a size threshold:
dividing the document into multiple segments, wherein each segment includes an indicator as to whether a particular segment is a final segment of the document; and
transmitting each of the multiple segments to, a remote computing device;
if the size of the document does not exceed a size threshold:
transmitting the document to the remote computing device; and
in response to receiving notification from the remote computing device that the document has been converted:
receiving the entire converted document from the remote computing device if the converted document is less that the size threshold; and
receiving one or more segments of the converted document from the remote computing device, wherein each of the one or more segments include an indicator as to whether a particular segment is a final segment of the converted document.

15. The computer-readable storage medium of claim 14, wherein receiving the entire converted document includes receiving at least a second converted document, if a size of the converted document and a size of the at least the second converted document do not exceed the size threshold.

16. The computer-readable storage medium of claim 14, further comprising instructions for saving the converted document to the storage location.

17. The computer-readable storage medium of claim 16, wherein the storage location is a local storage location.

18. The computer-readable storage medium of claim 14, wherein the final segment includes an indicator that instructs the remote computing device to initiate conversion of the document when the final segment has been received.

19. The computer-readable storage medium of claim 14, further comprising receiving periodic updates corresponding to the status of the conversion of the document wherein from the remote computing device.

20. The computer-readable storage medium of claim 14, wherein the storage location is a cloud storage location
